(19) United States
(12) Patent Application Publication
(10) Pub. No.: US 2020/0310189 A1
(43) Pub. Date: Oct. 1, 2020

(54) TERMINAL AND LIQUID CRYSTAL SCREEN

(71) Applicant: BEIJING XIAOMI MOBILE SOFTWARE CO., LTD., Beijing (CN)

(72) Inventors: Chiafu YEN, Beijing (CN); Jianglin GU, Beijing (CN)

(73) Assignee: BEIJING XIAOMI MOBILE SOFTWARE CO., LTD., Beijing (CN)

(21) Appl. No.: 16/587,345

(22) Filed: Sep. 30, 2019

(30) Foreign Application Priority Data
Mar. 29, 2019 (CN) 201910253169.0

(51) Int. Cl. G02F 1/1333; F21V 8/00; G02F 1/1335

(52) U.S. Cl. CPC G02F 1/133308; G02B 6/0081; G02F 1/133528; G02F 1/13338; G02F 2001/133314; G02F 2001/133334; G02F 1/133512

(57) ABSTRACT

A terminal and a liquid crystal screen are provided. The terminal includes: a liquid crystal display screen and a sensor. The liquid crystal display screen includes a liquid crystal layer and a backlight assembly. The backlight assembly is located below the liquid crystal layer. A first opening is formed in the backlight assembly. The sidewall of the first opening is provided with a light-shielding layer. The sensor is installed in alignment with the first opening, and the light-shielding layer is configured to prevent the light emitted by the backlight assembly from interfering with the sensor.

### CROSS-REFERENCE TO RELATED APPLICATION

This application claims priority to Chinese Patent Application 201910253169.0, filed Mar. 29, 2019, the entire contents of which are incorporated herein by reference.

### TECHNICAL FIELD

The present disclosure belongs to the field of display technology and relates to a terminal and a liquid crystal screen.

### BACKGROUND

Terminals are provided with sensors, such as cameras and optical fingerprint sensors, and such type of sensors are usually disposed at the front panel of the terminal.

### SUMMARY

The present disclosure provides a terminal and a liquid crystal screen as follows.

According to a first aspect of the present disclosure, there is provided a terminal comprising a liquid crystal display screen and a sensor, wherein the liquid crystal display screen comprises a liquid crystal layer and a backlight assembly below the liquid crystal layer; a first opening is formed in the backlight assembly, and a light-shielding layer is disposed on the sidewall of the first opening; and the sensor is in alignment with the first opening, and the light-shielding layer is configured to prevent the light emitted by the backlight assembly from interfering with the sensor.

According to a second aspect of the present disclosure, there is provided a liquid crystal screen, comprising a liquid crystal display screen, wherein the liquid crystal display screen comprises a liquid crystal layer and a backlight assembly below the liquid crystal layer; a first opening is formed in the backlight assembly, and the first opening is configured to place a sensor; and a light-shielding layer is disposed on the sidewall of the first opening, and the light-shielding layer is configured to prevent the light emitted by the backlight assembly from interfering with the sensor.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a side cross-sectional schematic view of a terminal in the related art.

FIG. 2 shows a side cross-sectional schematic view of a terminal, according to an embodiment of the present disclosure.

FIG. 3 shows a schematic diagram of a first opening structure of a terminal, according to an embodiment of the present disclosure.

FIG. 4 is a schematic diagram of a liquid crystal display screen of a terminal, according to an embodiment of the present disclosure.

FIG. 5 is a side cross-sectional schematic view of a terminal, according to an embodiment of the present disclosure.

FIG. 6 is a cross-sectional side schematic view of a terminal, according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the present disclosure. Instead, they are merely examples of devices and methods consistent with aspects related to the disclosure as recited in the appended claims.

The terminology used in the present disclosure is for the purpose of describing particular embodiments only and is not intended to limit the present disclosure. As used in the present disclosure and the appended claims, the singular forms “a”, “an” and “the” are intended to include the plural forms as well, unless the context clearly indicates otherwise. It shall also be understood that the term “and/or” used herein is intended to signify and include any or all possible combinations of one or more of the associated listed items.

It shall be understood that, although the terms “first”, “second”, “third”, etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to a judgment” depending on the context.

It shall be understood that the screen in the device has a front and back. Where the front of the screen faces away from the device towards a user. And the back of the screen faces the inner components of the device. For example, the back of the screen faces the battery of the device.

For the purpose of increasing the screen-to-body ratio of the terminal, the current mainstream method is to design an under-screen sensor. In such design, the sensor is disposed below the display screen, and the position of the display screen corresponding to the sensor is constructed as a through hole structure. The through hole structure includes an opening A in the liquid crystal layer and an opening B of the backlight assembly, and the opening B is configured to place the sensor.

In this design, since after openings are formed in the liquid crystal screen, the opening A in the liquid crystal layer needs to be subjected to a liquid crystal edge sealing treatment, and the opening B of the backlight assembly needs to be subjected to a light-shielding treatment, the black edge of the liquid crystal screen at the through hole will be too wide, which seriously affects the aesthetics of the terminal.

In some embodiments of the present disclosure, only the backlight assembly below the liquid crystal layer will be punched, the liquid crystal layer will not be punched, the sensor or the photosensitive portion of the sensor is disposed in the first opening below the liquid crystal layer, and the liquid crystal edge sealing operation is not required, thereby avoiding the black edge of the liquid crystal screen at the through hole is too wide. Since the light-shielding layer is disposed on the sidewall of the first opening, a support structure is not required, and the area of the liquid crystal layer occupied by the light-shielding layer is relatively small, thereby effectively reducing the width of the black edge at the first opening and improving the aesthetics of the terminal.

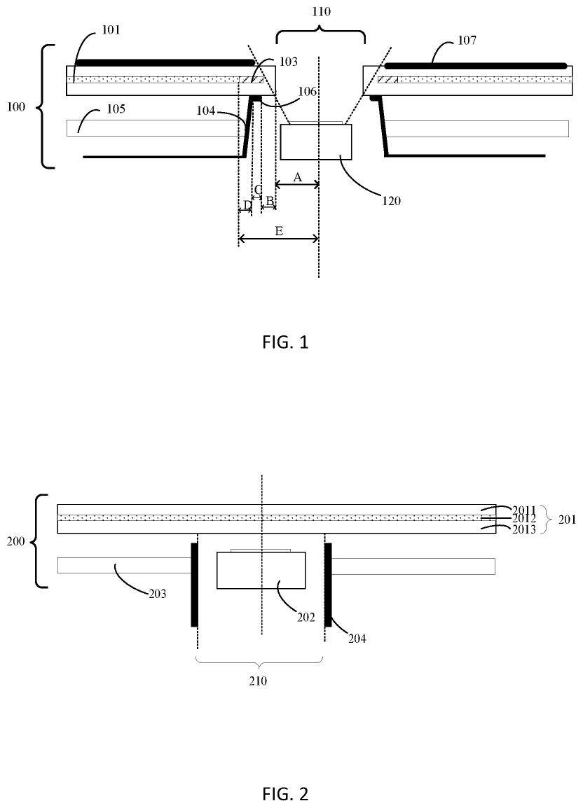

FIG. 1 illustrates a side cross-sectional schematic view of a terminal in the related art. The terminal includes a liquid crystal display screen 100 and a sensor 120 disposed below the liquid crystal display screen.

The liquid crystal display screen 100 includes a liquid crystal layer 101 and a backlight assembly 105 disposed below the liquid crystal layer 101, and the liquid crystal layer 101 and the backlight assembly 105 are disposed in a stacked manner. The liquid crystal layer is provided with a first opening, and the backlight assembly 105 is provided with a second opening. The first opening and the second opening form a through hole 110 of the liquid crystal display screen.

The liquid crystal layer 101 includes an upper glass substrate, a lower glass substrate, and liquid crystal disposed between the upper glass substrate and the lower glass substrate. Since the first opening is disposed in the liquid crystal layer 101, in order to prevent the liquid crystal from flowing out, the first opening of the liquid crystal layer 101 is provided with a liquid crystal sealing edge 103, and the liquid crystal sealing edge has a first width.

The backlight assembly 105 at least includes a light source and a light guide plate. In order to prevent the light source of the backlight assembly 105 from affecting the operation of the sensor 120, an iron frame structure 104 is disposed around the second opening. The iron frame structure 104 is fixed on the lower glass substrate of the liquid crystal layer 101 by an iron frame sealant 106. The iron frame structure 104 and the iron frame sealant 106 have a second width.

In the related art, in order to ensure that the sensor disposed below the screen works normally, it is necessary to set the viewing angle of the sensor, the reserved gap A of the liquid crystal sealing edge 103, the distance B between the iron frame sealant 106 and the viewing angle, the size C of the iron frame sealant 106, as well as the size D of the iron frame structure 104 and the liquid crystal sealing edge 103, and the first width and the second width are combined. As a result, the black edge at the through hole 110 is too wide, which seriously affects the aesthetics of the terminal.

FIG. 2 shows a side cross-sectional schematic view of a terminal provided by an embodiment of the present disclosure. The terminal includes a liquid crystal display screen 200 and a sensor 202. The liquid crystal display screen 200 has a top side and bottom side. The top side faces the user and the bottom side faces the device. The liquid crystal display screen 200 includes a liquid crystal layer 201 and a backlight assembly 203 located below the liquid crystal layer 201.

The liquid crystal layer 201 includes an upper glass substrate 2011, a lower glass substrate 2013, and liquid crystal 2012 disposed between the upper glass substrate 2011and the lower glass substrate 2013 and configured to display picture content.

The backlight assembly 203 is provided with a first opening 210, and the sensor 202 is mounted in alignment with the first opening 210. For example, the sensor 202 can be mounted inside or below the first opening 210. In another example, the backlight assembly 203 at least includes a light source and a light guide plate, and is configured to provide a light source with uniform brightness for the liquid crystal display screen 200.

The sidewall of the first opening 210 is provided with a light-shielding layer 204. The light-shielding layer 204 is configured to prevent the light emitted by the backlight assembly 203 from interfering with the operation of the sensor 202.

For example, the light-shielding layer 204 is attached to the sidewall of the first opening 210, and does not need a support structure, so that the light emitted by the backlight assembly 203 around the first opening is effectively blocked in a case where the occupied regional area of the liquid crystal layer 201 is relatively small.

According to the present embodiment, only the backlight assembly below the liquid crystal layer will be punched, the liquid crystal layer will not be punched, the sensor or the photosensitive portion of the sensor is disposed in the first opening below the liquid crystal layer, and the liquid crystal edge sealing operation is not required, thereby avoiding the black edge of the liquid crystal screen at the through hole is too wide. Since the light-shielding layer is disposed on the sidewall of the first opening, a support structure is not required, and the area of the liquid crystal layer occupied by the light-shielding layer is relatively small, thereby effectively reducing the width of the black edge at the first opening and improving the aesthetics of the terminal.

In another embodiment based on FIG. 2, the light-shielding layer 204 is light-shielding coating formed on the sidewall. After being disposed on the sidewall of the first opening 210, the light-shielding coating can absorb or reflect the light of the backlight assembly 203 for preventing the light emitted by the backlight assembly 203 from interfering with the operation of the sensor 202. Illustratively, the light-shielding coating may be silicone coating or fluorocarbon coating, etc. It should be noted that the above light-shielding coatings are only examples, and other coatings may also be used. The present embodiment does not limit the type and component of the light-shielding coating.

For example, the light-shielding layer 204 is a light-shielding film formed on the sidewall. The light-shielding film is a film-like structure and is disposed on the sidewall of the first opening 210.

For example, the light-shielding film is formed on the sidewall by a coating process or a screen-printing process. The thickness of a projection of the light-shielding layer onto the liquid crystal layer is less than 0.4 mm.

Since the light-shielding film is a film-like structure, when the light-shielding film is disposed on the sidewall of the first opening 210, no gap is formed between the layers in the backlight assembly 203, and it can be ensured that the sidewall of the first opening is in a light-shielding state. Meanwhile, due to the coating or screen-printing process, the light-shielding material can be set to be a relatively thin film structure, and the light-shielding layer 204 is attached to the sidewall of the first opening 210. Therefore, the support structure is not required, no gap is formed between the support structure and the backlight assembly, and no further excessive space under the screen is occupied, thereby effectively reducing and the unrealistic regional area of the liquid crystal layer 201, and further reducing the black edge width at the first opening 210.

It should be noted that the manner in which the light-shielding layer 204 is disposed on the sidewall of the first opening 210 is not limited to the screen-printing process or the coating process provided in the above embodiment, and other manners may also be used, and are not limited in the present embodiment.

For example, the sensor 202 is a photosensitive sensor. The sensor 202 is a sensor which operates according to received external light. Illustratively, the sensor 202 includes any one of a camera, a distance sensor, and an ambient light sensor.

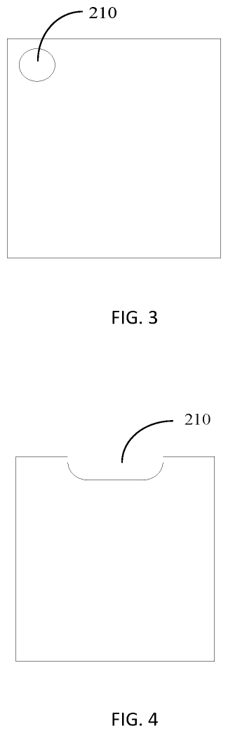

Based on the embodiment of FIG. 2, in conjunction with FIG. 3, FIG. 3 is a structural schematic diagram of a first opening of a terminal provided by an embodiment of the present disclosure. The first opening 210 is an edge-closed opening structure. For example, the shape of the first opening 210 includes at least one of a circular opening, a water drop-shaped opening, an elliptical opening, a rectangular opening, and an irregular shaped opening. Alternatively, the first opening includes a semi-open groove structure formed at the edge of the backlight assembly.

In conjunction with FIG. 4, FIG. 4 is a schematic diagram of a liquid crystal display screen of a terminal provided by another embodiment of the present disclosure. The first opening 210 below the liquid crystal layer is a semi-open structure, which includes a semi-open rounded rectangular shape (fringe screen), or a semi-open semi-circular (pearl screen) structure.

For example, the opening is formed by laser breakdown, or die cutting.

For example, the first opening 210 is perpendicular to the liquid crystal layer 201, and the photosensitive portion of the sensor 202 or the sensor 202 is disposed in the first opening 210 or below the first opening 210. External light passes through the transparent the liquid crystal layer 201 and enters the sensor 202, so that the sensor 202 can operate normally.

It should be noted that, in the present embodiment, the shape, the forming manner, and the opening angle of the first opening 210 are only examples, and can be adjusted correspondingly according to the actual situation, which is not limited in this disclosure.

According to the embodiment, the opening is disposed below the liquid crystal layer. Since the edge sealing of the liquid crystal layer is not involved, the shape of the opening can be flexibly set according to the type and shape of the sensor, and can be applied to the design of most under-screen sensors.

FIG. 5 illustrates a side cross-sectional schematic view of a terminal provided by an embodiment of the present disclosure. The liquid crystal layer 101 is a thin-film-transistor (TFT) liquid crystal layer. The TFT liquid crystal layer is further provided with a polarizer 204. A second opening 220 is formed in the region of the polarizer 204 corresponding to the first opening 210.

In order to ensure the display effect and brightness adjustment of the TFT liquid crystal layer, the polarizer 204 is disposed on the TFT liquid crystal layer in an attaching manner, and the polarizer 204 is provided with the second opening 220 matched with the first opening 210 in position.

For example, the second projection range of the second opening 220 onto the liquid crystal layer covers the first projection range of the first opening 210 onto the liquid crystal layer, that is, the second projection range of the second opening 220 is not less than the first projection range of the first opening 210 onto the liquid crystal layer, and the first projection range is within the second projection range. The first projection range and the second projection range refer to the regions of the liquid crystal layer 201, which are formed by the fact that the second opening 220 and the first opening 210 are subjected to projection operation in a manner of being perpendicular to the liquid crystal layer 201.

For example, the second projection range is not less than the range of the viewing angle of the sensor 202. The viewing angle is the angle of the maximum light-taking range of the sensor 202. By taking the camera as an example of the sensor 202, the viewing angle of the camera is the maximum viewing range that can be obtained by the camera without interference. In order to ensure that the polarizer 204 does not affect the viewing range of the camera, the second opening 220 on the polarizer should be set to be equal to or slightly larger than the range of the viewing angle. In an example implementation manner, the sensor is not limited to the camera, and may be at least one of an ambient light sensor, a distance sensor, or a photosensitive fingerprint sensor.

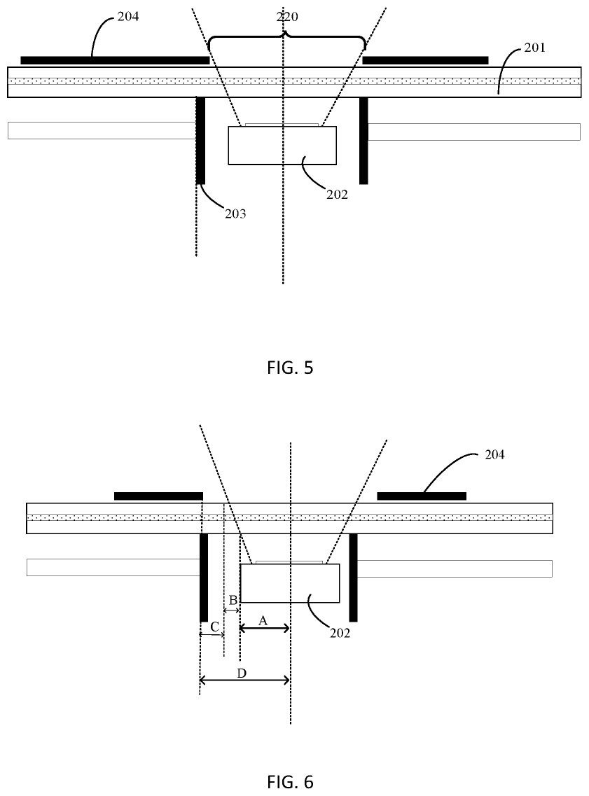

In conjunction with FIG. 6, the liquid crystal layer does not need the edge sealing operation, and the liquid crystal display range is only decided by the size A of the sensor per se, the distance B between the viewing angle and the point of intersection between the upper and lower glass substrates, and the gap C reserved between the polarizer and the viewing angle. The thickness of the light-shielding film is relatively low and is generally smaller than the range of the distance B, and the light-shielding layer does not require an additional space for a support member. Therefore, the influence of the light-shielding layer on the unrealistic region of the terminal display screen can be controlled to be a smaller value, and the width of the black edge of the liquid crystal screen at the opening is further reduced.

The disclosure further provides a liquid crystal screen. The liquid crystal screen includes a liquid crystal display screen, and the liquid crystal display screen includes a liquid crystal layer and a backlight assembly located below the liquid crystal layer. A first opening is formed in the backlight assembly, and the first opening is configured to place a sensor. The sidewall of the first opening is provided with a light-shielding layer. The light-shielding layer is configured to prevent the light emitted by the backlight assembly from interfering with the sensor.

For example, the light-shielding layer is light-shielding coating formed on the sidewall.

For example, the light-shielding layer is a light-shielding film formed on the sidewall.

For example, the light-shielding film is formed on the sidewall by a coating process or a screen-printing process.

For example, the thickness of a projection of the light-shielding layer onto the liquid crystal layer is less than 0.4mm.

For example, the first opening includes at least one of a circular opening, a water drop-shaped opening, an elliptical opening, a rectangular opening, and an irregular shaped opening. Or the first opening includes a semi-open groove structure formed on the edge of the backlight assembly.

For example, the liquid crystal layer is a TFT liquid crystal layer, and a polarizer is further disposed on the TFT liquid crystal layer. A second opening is formed in the region of the polarizer corresponding to the first opening.

For example, the second projection range of the second opening onto the liquid crystal layer covers the first projection range of the first opening onto the liquid crystal layer. This means that the second projection range of the second opening is not less than the first projection range of the first opening onto the liquid crystal layer, and the first projection range is within the second projection range.

For example, the second projection range is not less than the range of the viewing angle of the sensor.

The structures of the liquid crystal layer and the backlight assembly in the above liquid crystal screen refer to the foregoing content of FIG. 2 to FIG. 4, and details are not described herein again.

In some embodiments of the present disclosure, only the backlight assembly below the liquid crystal layer will be punched, the liquid crystal layer will not be punched, the sensor or the photosensitive portion of the sensor is disposed in the first opening below the liquid crystal layer, and the liquid crystal edge sealing operation is not required, thereby avoiding the black edge of the liquid crystal screen at the through hole is too wide. Since the light-shielding layer is disposed on the sidewall of the first opening, a support structure is not required, and the area of the liquid crystal layer occupied by the light-shielding layer is relatively small, thereby effectively reducing the width of the black edge at the first opening and improving the aesthetics of the terminal.

Understandably, the term “plurality” herein refers to two or more. “And/or” herein describes the correspondence of the corresponding objects, indicating three kinds of relationship. For example, A and/or B, can be expressed as: A exists alone, A and B exist concurrently, B exists alone. The character “/” generally indicates that the context object is an “OR” relationship.

The numerals in the present disclosure are merely intended for description and do not represent any merits.

Persons of ordinary skill in the art can understand that all or part of the steps described in the above embodiments can be completed through hardware, or through hardware instructed by applications stored in a non-transitory computer readable storage medium, such as a read-only memory, a disk or a CD, etc.

The foregoing descriptions are merely preferred embodiments of the present disclosure, and are not intended to limit the present disclosure. Within the spirit and principles of the disclosure, any modifications, equivalent substitutions, improvements, etc., are within the protection scope of the present disclosure.

What is claimed is:

1. A terminal, comprising:
a liquid crystal display screen and a sensor,
wherein the liquid crystal display screen comprises a liquid crystal layer and a backlight assembly, wherein the backlight assembly is located below the liquid crystal layer and comprises a first opening and a sidewall, wherein the first opening is formed in the backlight assembly, and a light-shielding layer is disposed on the sidewall of the first opening; and
wherein the sensor is mounted in alignment with the first opening, wherein the light-shielding layer is configured to prevent the light emitted by the backlight assembly from interfering with the sensor.

2. The terminal according to claim 1, wherein the light-shielding layer is light-shielding coating formed on the sidewall.

3. The terminal according to claim 1, wherein the light-shielding layer is a light-shielding film formed on the sidewall.

4. The terminal according to claim 3, wherein the light-shielding film is formed on the sidewall by either a coating process or a screen-printing process.

5. The terminal according to claim 1, wherein a projection of the light-shielding layer onto the liquid crystal layer has a thickness of less than 0.4 mm.

6. The terminal according to claim 1, wherein
the first opening comprises at least one of a circular opening, a water drop-shaped opening, an elliptical opening, a rectangular opening, and an irregular shaped opening.

7. The terminal according to claim 1, further comprising a second opening,
wherein the liquid crystal layer is a thin-film-transistor (TFT) liquid crystal layer comprising a polarizer layer; and
the second opening is formed in the polarizer layer and aligns with the location of the first opening.

8. The terminal according to claim 7, wherein a second projection range of the second opening onto the liquid crystal layer covers a first projection range of the first opening onto the liquid crystal layer.

9. The terminal according to claim 7, wherein the second projection range is not less than the range of a viewing angle of the sensor.

10. A liquid crystal screen, comprising a liquid crystal display screen, wherein the liquid crystal display screen comprises a liquid crystal layer and a backlight assembly, wherein the backlight assembly is located below the liquid crystal layer;
wherein a first opening is formed in the backlight assembly, and the first opening is configured to contain a sensor; and
wherein a light-shielding layer is disposed on the sidewall of the first opening, and the light-shielding layer is configured to prevent the light emitted by the backlight assembly from interfering with the sensor.

11. The liquid crystal screen according to claim 10, wherein the light-shielding layer is light-shielding coating formed on the sidewall.

12. The liquid crystal screen according to claim 10, wherein the light-shielding layer is a light-shielding film formed on the sidewall.

13. The liquid crystal screen according to claim 12, wherein the light-shielding film is formed on the sidewall by either a coating process or a screen-printing process.

14. The liquid crystal screen according to claim 10, wherein a projection of the light-shielding layer onto the liquid crystal layer has a thickness of less than 0.4 mm.

15. The liquid crystal screen according to claim 10, wherein the first opening comprises at least one of a circular opening, a water drop-shaped opening, an elliptical opening, a rectangular opening, and an irregular shaped opening.

16. The liquid crystal screen according to claim 10, wherein the liquid crystal layer is a thin-film-transistor (TFT) liquid crystal layer, and the TFT liquid crystal layer is further provided with a polarizer layer; and
wherein a second opening is formed in the polarizer layer and corresponds to the location of the first opening.

17. The liquid crystal screen according to claim 17, wherein a second projection range of the second opening onto the liquid crystal layer covers a first projection range of the first opening onto the liquid crystal layer.

18. The liquid crystal screen according to claim 17, wherein the second projection range is not less than the range of a viewing angle of the sensor.

19. The terminal according to claim 1, wherein the first opening comprises a semi-open groove structure formed at the edge of the backlight assembly.

20. The liquid crystal screen according to claim 10, wherein the first opening comprises a semi-open groove structure formed at the edge of the backlight assembly.
